(19) United States
(12) Patent Application Publication
(10) Pub. No.: US 2006/0105112 A1
(43) Pub. Date: May 18, 2006

(54) Decorative painting kit

(76) Inventor: Robert Ives Janssen, Mendota Heights, MN (US)

Correspondence Address: Carl L. Johnson;Jacobson and Johnson, Suite 285, One West Water Street, St. Paul, MN, 55107-2080, US

(21) Appl. No.: 11/280,750

(22) Filed: Nov. 16, 2005

Related U.S. Application Data
(60) Provisional application No. 60/628,484, filed on Nov. 16, 2004.

(51) Int. Cl. B05D 5/00; B05C 11/00; B05D 1/28

(52) U.S. Cl. 427/429; 427/256; 118/264

(57) ABSTRACT

A paint kit and method for decorative color painting, the paint kit comprising a paint transfer member for receiving and carrying a load of at least two different color paints in a side-by-side condition and a paint applicator for lifting at least a partial load of one of the at least two different color paints from the paint transfer member to a surface area to be painted and applying and blending the at least two different colored paints on the surface to be decoratively painted through contact between the paint applicator and the surface area to be decoratively painted.

### CROSS REFERENCE TO RELATED APPLICATIONS

This application claims priority to pending U.S. Provisional Application Ser. No. 60/628,484, which was filed on Nov. 16, 2004.

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates generally to decorative painting and, more specifically, to a decorative painting kit and a method of using the decorative painting kit for the decorative color painting and blending of at least two different colored paints using different painting techniques.

### BACKGROUND OF THE INVENTION

The concept of decorative pattern painting by using various types of decorative paint applicators to apply different colored paint in various patterns is known in the art. The method for the aforementioned usually comprises at least a two-step process. Typically, a surface is first painted with a first colored paint after which a decorative paint applicator such as a sponge or rag is used to layer second and third colors of paint to the surface, each color being applied overall to the surface in a one coat/one color application.

For example: The world popular wall painting technique of decorative painting called “Sponge Painting” involves the use of a sponge applicator, which is dipped into a container holding a second colored paint after which the sponge is blotted on a newspaper, to remove excess paint. The second colored paint is then applied to the base painted surface by stamping the loaded sponge applicator to that base painted surface to produce a decorative painted effect.

Although current methods of decorative paint layering, such as sponge painting, and ragging can produce beautiful results, many painters complain that these techniques are very labor intensive and that the repeated stamping movements of arm, wrist, and hand are more then they can bear.

For over 100 years the recognized wall paint layering techniques of sponging, ragging, color washing, rag rolling, pattern rolling, and others have changed very little, if at all. Paint chemistry has changes in recent years, which change to fast drying, water based, water cleanup, latex, and acrylic wall paints has not been matched by much needed improvements in the tools and technique of application.

### SUMMARY OF THE INVENTION

The present invention provides a paint layering kit that includes new paint layering tools to be used in a newly described paint layering technique that is both time saving and physically less stressful than traditional paint layering techniques.

The kit comprises a multi-color paint palette having a brush-like fibered surface (or other paint retaining surface) which surface is loaded simultaneously with paints of various colors by wiping the palette surface on paint dispensing wheels that revolve in color cups each containing a paint of different color and sometimes different chemistry.

Having loaded the paint palette with paints of one or more colors, a sponge, rag, paint brush, crumbled newspaper, Nomad™ or similar, or other object, is used as an applicator tool to pickup paints from the palette and transfer them to a surface in a decorative arrangement of colors and pattern. One advantage of the above is that it eliminates the need to “blot off” excess paint from the paint tool thereby reducing the time of the painting project.

The surface of the paint palette carries a relatively larger supply of the various paints being applied as compared to the paint supply in the applicator tool. The paint person carries a palette load of paint in one hand and the applicator tool in the other hand. The paint person can now move about, even up a ladder, and continue to apply paints in multiple colors with many fewer trips to the principal paint container. This is a significant time saver as it reduces the time spent in carrying paint to the wall.

### BRIEF DESCRIPTION OF THE DRAWINGS

FIG. 1 shows a decorative painting kit having a sponge applicator for sponge painting;

FIG. 2 is a perspective view showing the individual parts of the decorative painting kit of FIG. 1;

FIG. 3 is a perspective view showing the placement of charges of different colored paints into the removable containers that are supported by a paint tray;

FIG. 4 is a perspective view showing the loading of a portion of the charges of paint from each of the removable containers to the paint transfer member;

FIG. 5 is a bottom view showing the pad region of the paint transfer member supporting a portion of the charges of each of the colored paint thereon;

FIG. 6 is a perspective view showing the transfer of the first colored paint supported on the paint transfer member to a portion of a sponge applicator;

FIG. 7 is a perspective view showing the sponge applicator loaded with two different colored paints;

FIG. 8 shows a first region of a surface area to be painted having with a first colored paint applied thereon;

FIG. 8A shows the first region of a surface area to be painted having with a first colored paint and a second colored paint decoratively blended thereon;

FIG. 9 shows a second region of a surface area to be painted having with a first colored paint applied thereon;

FIG. 9A shows the second region of a surface area to be painted having with a first colored paint and a second colored paint decoratively blended thereon;

FIG. 10 shows a decorative painting kit having four removable containers and a sponge applicator for sponge painting;

FIG. 10A is a perspective view showing the individual parts of the decorative painting kit of FIG. 10;

FIG. 11 shows a rag cloth roller applicator for use with the decorative painting kit of the present invention;

FIG. 12 shows a woven fiber applicator for use with the decorative painting kit of the present invention;

FIG. 13 shows an alternative embodiment of a decorative painting kit of the present invention;

FIG. 14 shows a close-up side view of a sponge applicator of FIG. 13;

FIG. 14A shows a side view of the sponge applicator of FIG. 14 in a distorted condition; and

FIG. 15 shows a side view of the paint transfer of FIG. 13 in an assembled condition.

### DESCRIPTION OF THE PREFERRED EMBODIMENT

The present invention comprises a decorative painting kit and a method of using the decorative painting kit for decorative color painting. The decorative painting kit comprises a paint tray assembly, a paint transfer member, and a paint applicator for decoratively applying paint(s) to a surface area to be painted. The tray assembly of the decorative painting kit of the present invention comprises a paint tray having multiple paint containers supported therein with each of the paint containers of the paint tray having a paint dispenser supported therein for loading paint from the container to the paint transfer member. The decorative painting kit of the present invention can also include instructions for using the decorative painting kit.

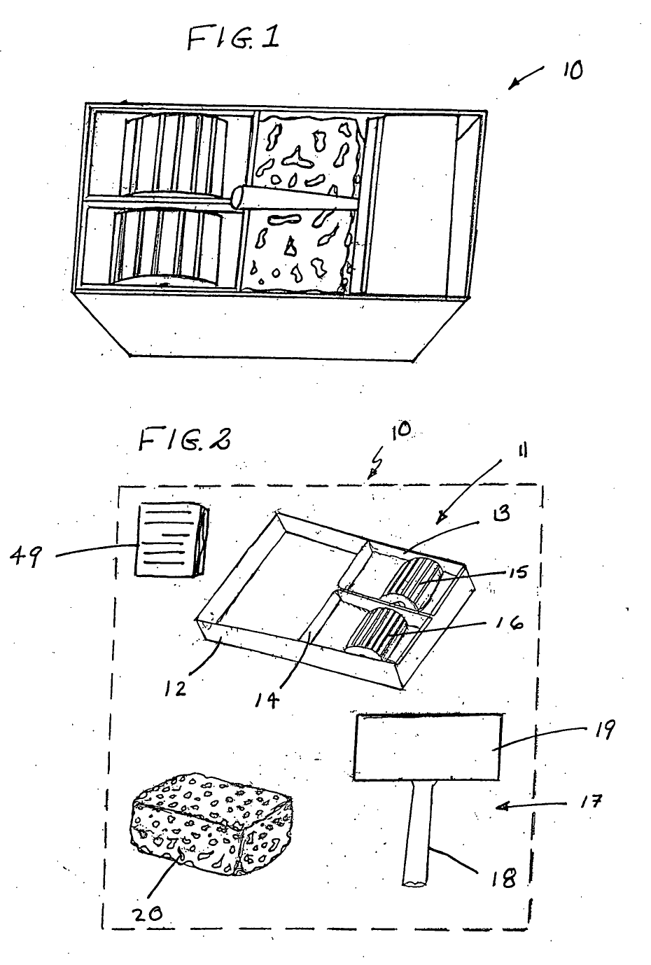

Referring to FIGS. 1 and 2, FIGS. 1 and 2 both show a decorative painting kit 10 of the present invention for decorative color painting with FIG. 1 showing decorative painting kit 10 in a shipped condition and FIG. 2 showing the individual parts of the decorative painting kit 10. Although decorative painting kit 10 will be mainly describes hereafter as being use for the fast and easy special effects painting using multiple colors with the multiple colors applied in a wet-against-wet condition to a surface area to be painted, it is noted that decorative painting kit 10 can be used for special effects painting using a single paint color.

The decorative painting kit 10 of the present invention as shown in FIGS. 1 and 2 comprises a paint tray assembly 11, a paint transfer member 17 having a handle region 18 and a pad region 19 for receiving paint thereon, a paint applicator comprising a sponge applicator 20 for decoratively applying the paint to a surface area to be painted, and instructions 49 for using the decorative painting kit 10. In regards to paint transfer member 17, the pad region 19 of paint transfer member 17 can include surface protrusions or bristles thereon for retaining paint in a localized area.

In regards to paint tray assembly 11, paint tray assembly 11 as shown in FIGS. 1 and 2 comprises a paint tray 12 having a first removable container 13 and second removable container 14 supported therein, the first removable container 13 for holding a charge of a first color paint therein and the second removable container 14 for holding a charge of a second color paint therein. In regards to paint tray 12, it is noted that paint tray 12 can be formed from a plurality of material including, wood, plastic and cardboard. For example, paint tray 12 can comprises a shipping carton such as a disposable cardboard shipping carton which service the dual purpose of supporting the removable containers therein during the painting process while also supporting the individual parts of the decorative painting kit 10 therein during shipping for display on store shelves.

It is noted that although alternative embodiments of paint tray assembly 11 can include a paint tray having at least one of the container permanently fixed to the paint tray, a feature of decorative painting kit 10 is that containers 13 and 14 are each removable from the paint tray 12 without removal of the other container from paint tray 12. The removability of each of the containers 13 and 14 allow the user to return any surplus paint back to its original container by removing each of the containers containing the surplus paint from the paint tray 12 and pouring each of the surplus paint to their respective original container without the potential for paint contamination through the mixing of the different colored paints.

Referring to FIG. 2, located within each of the removable paint containers 13 and 14 is at least one paint dispenser for delivering paint located in the removable containers 13 and 14 to the paint transfer member 17. More specifically, located in first removable container 13 is a paint dispenser comprising a first paint roller dispenser 15 and located in second removable container 14 is a paint dispenser comprising a second paint roller dispenser 16, paint roller dispensers 15 and 16 functioning to simultaneously load a portion of a charge of the first colored paint located in the first removable container and a portion of a charge of the second colored paint located in the second removable containers of the receiving paint area of paint transfer member 17. Although the first and second colored paints may comprise the same color, it is preferred that the first and second colored paints comprise the different colors.

It is noted that paint roller dispensers 15 and 16 can either be supported in removable containers 13 and 14 as the charges of color paint are placed in the removable containers 13 and 14 or alternatively, can be placed in removable container 13 and 14 after the charges of color paints have been placed in the removable containers 13 and 14.

In regards to the paint applicator for use with the decorative painting kit of the present invention, although decorative painting kit 10 is shown and described hereafter as including a paint applicator comprising sponge applicator 20 for the painting of the decorative painting technique called sponge painting which involves the application of at least two different colored paints to a surface area to be painted using sponge applicator 20, it is noted that a feature of the decorative painting kit of present invention is that the present invention allows for the painting of other decorative painting techniques including but not limited to rag-rolling, marbling, stucco-rolling, and spatter-painting by using different types of paint applicators such as but not limited to a woven fiber roller applicator, a brush roller applicator, and a rag cloth roller applicator with the present invention.

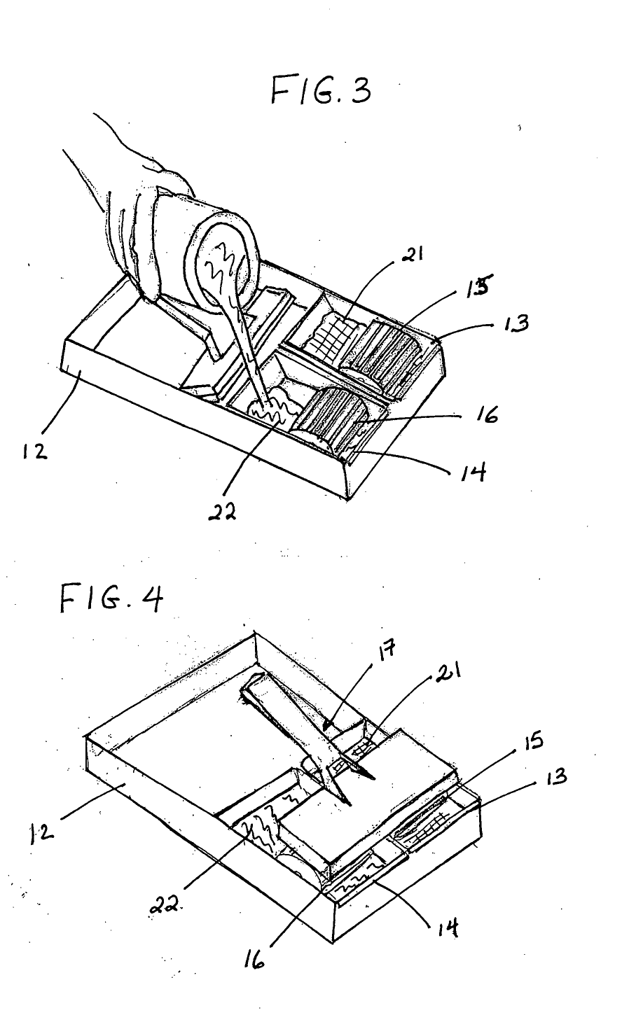

FIGS. 3, 4, 5, 6, 7, 8, 8A, 9, and 9A, FIGS. 3, 4, 5, 6, 7, 8, 8A, 9, and 9A show the use of decorative painting kit 10 for the sponge painting of a surface area. More specifically, referring to FIG. 3, FIG. 3 shows the placement of a charge of a first colored paint 21 into the first removable container 13 and the placement of a charge of a second colored paint 22 into the second removable container 14 of paint tray 12. It is preferred that the first colored paint 21 and second colored paint 22 each comprises a color that is different from the other. Although not shown, when placing the charges of different colored paint into removable containers 13 and 14, it is preferred that each charge of different colored paint be limited such that the paint level in removable containers 13 and 14 does not extend above the axle of paint roller dispensers 15 and 16.

Once the charges of different colored paint have been placed in the removable containers 13 and 14 of the paint tray 12 with the paint roller dispensers 15 and 16 supported therein, the paints 21 and 22 held in each of the removable container 13 and 14 is absorbed by their respective roller dispenser 15 and 16.

Referring to FIG. 4, after each of the different colored paints 21 and 22 are absorbed by their respective roller dispenser 15 and 16, a portion of each of the charges of the different colored paints 21 and 22 are then loaded to paint transfer member 17 by the movement of the paint transfer member 17 tangentially across the paint roller dispensers 15 and 16. More specifically, movement of the paint transfer member 17 tangentially across the paint roller dispensers 15 and 16 causes paint roller dispensers 15 and 16 to rotate thereby simultaneously carrying the portion of the charge of the first colored paint 21 to a first paint receiving area 19A located on the pad region 19 of paint transfer member 17 and the portion of the charge of the second colored paint 22 to a second paint receiving area 19B located on the pad region 19 of paint transfer member 17 thereby loading the paint transfer member 17 with portions of each of the charges of the different colored paints 21 and 22 as shown in FIG. 5.

After the paint transfer member 17 has been loaded with the portions of each of the charges of the different colored paints 21 and 22, the different colored paints are then transferred to the sponge paint applicator 20 for application to a surface to be painted. It is noted that the different colored paint can be transferred to the paint applicator by different methods depending on the type of decorative paint applicators that is used.

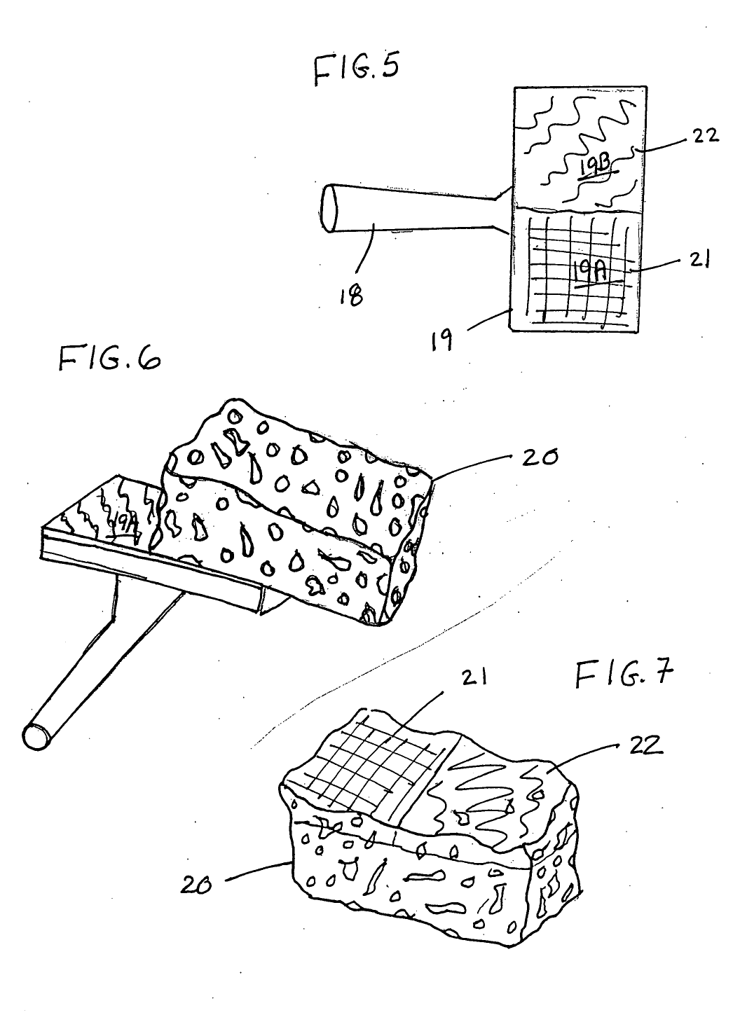

For example, referring to FIGS. 6, 7, 8, 8A, 9, and 9A, for sponge painting using the decorative painting kit 10, it is preferred that paint transfer member 17, when loaded with paint, is use as a paint palette-like device in the transfer of paint to the sponge applicator 20 and ultimately to a surface area 23 to be paint.

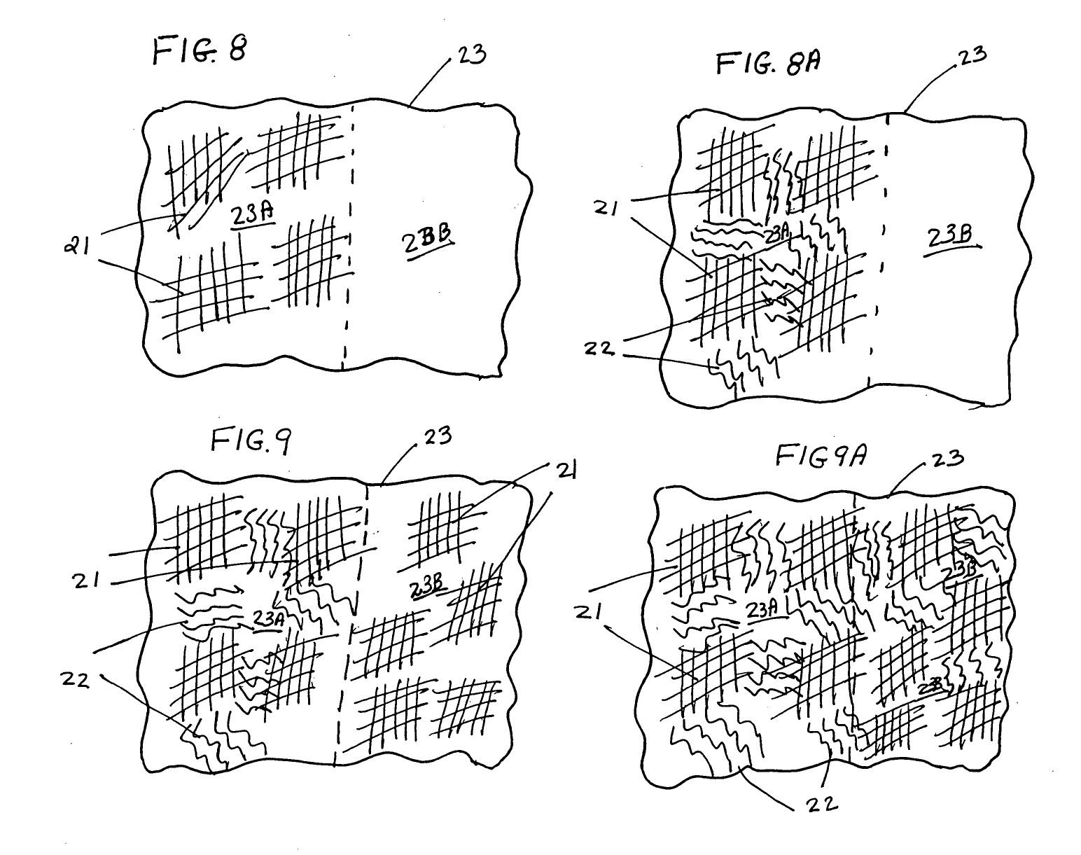

More specifically, referring to FIG. 6, in applying paint to surface area 23 using sponge applicator 20 as shown in FIGS. 8, 8A, 9, and 9A, the user first daubs a portion of the sponge paint applicator 20 to the first paint receiving area 19A of pad region 19 to load the first colored paint 21 to the sponge paint applicator 20. Referring to FIG. 8, once the first colored paint 21 is loaded to sponge paint applicator 20, the portion of sponge applicator 20 loaded with the first colored paint 21 is then repeatedly daubed across a first region 23A of surface area 23 to decoratively apply the first colored paint 21 to the first region 23A of surface area 23.

After the first colored paint 21 has been decoratively applied to the first region 23A of surface area 23 by sponge paint applicator 20 but while the first colored paint 21 is still wet, the user then loads the second colored paint 22 from the second paint receiving area 19A of pad region 19 to the sponge paint applicator 20 and then repeatedly daubs the portion of sponge applicator 20 loaded with the second colored paint 22 across the first region 23A of surface area 23 to produce a region of partially blended colors 21 and 22 under a wet-on-wet or wet-against-wet condition as shown in FIG. 8A.

Once the first region 23A of surface area 23 has been decoratively painted through a partially blending of colors 21 and 22 under a wet-against-wet condition, the above step are then repeated to decoratively paint the second region 23B of surface area 23 as shown in FIGS. 9 and 9A. That is, the first colored paint 21 is first applied to second region 23B of surface area 23 by sponge paint applicator 20 followed by the application of the second colored paint 22 to second region 23B of surface area 23 by sponge paint applicator 20 while the first colored paint 21 is still wet to produce a region of partially blended colors 21 and 22 under wet-on-wet condition.

It is noted that a benefit of using the paint transfer member 17 for loading paint to the sponge applicator instead of directly loading paint to the sponge applicator is that since use of the paint transfer member 17 enables the user to control the amount of colored paint loaded to sponge applicator 20, use of the paint transfer member 17 eliminates the need for blotting the sponge applicator 20, such as on newspaper, to remove uneven and excess paint from the sponge applicator before the sponge applicator is applied to service area 23.

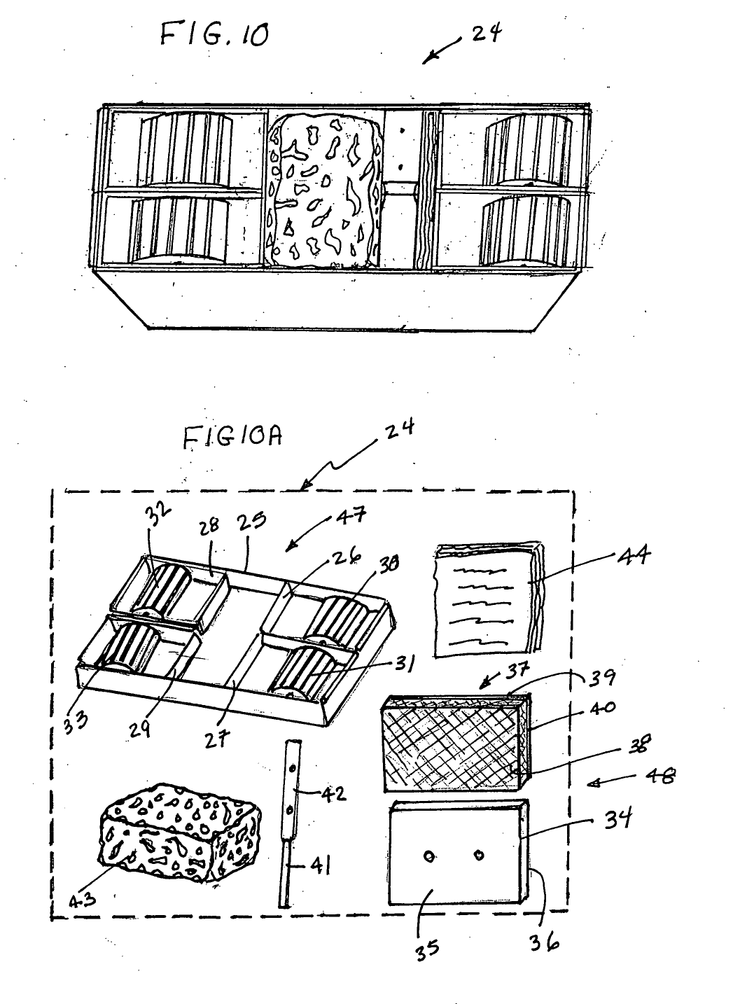

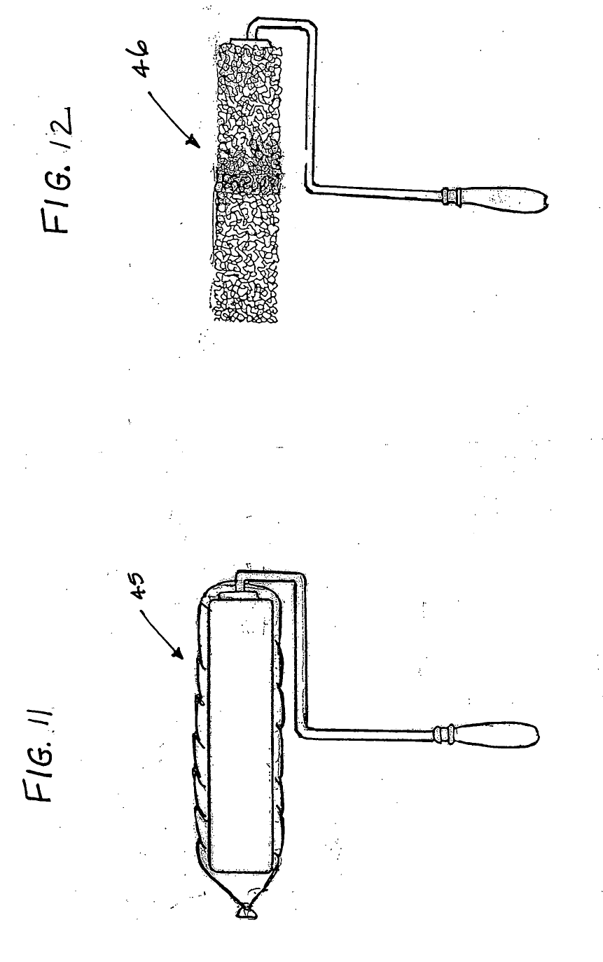

Referring to FIGS. 10 and 10A, FIGS. 10 and 10A both show an alternative embodiment of a decorative painting kit 24 of the present invention similar to decorative painting kit 10 for decorative color painting. The decorative painting kit 24 of the present invention as shown in FIGS. 10 and 10A comprises a paint tray assembly 47, a paint transfer member assembly 48, a paint applicator comprising sponge applicator 43 for decoratively applying and partially blending the colored paint to a surface area to be painted, and instructions 44 for using the decorative painting kit 24.

In regards to paint tray assembly 47, paint tray assembly 47 as shown in FIG. 10A comprises a paint tray 25 having a first removable container 26, a second removable container 27, a third removable container 28 and a fourth removable container 29 supported therein, the first removable container 26 for holding a charge of a first color paint therein, the second removable container 27 for holding a charge of a second color paint therein, the third removable container 28 for holding a charge of a third color paint therein and the fourth removable container 29 for holding a charge of a fourth color paint therein.

Located within each of the removable paint containers 26, 27, 28, and 29 is at least one paint dispenser for delivering paint located in the removable container to a paint pad transfer member. More specifically, located in first removable container 26 is a first paint roller dispenser 30, located in second removable container 27 is a second paint roller dispenser 31, located in third removable container 28 is a third paint roller dispenser 32 and located in fourth removable container 29 is a fourth paint roller dispenser 33. Paint roller dispensers 30, 31, 32 and 33 function to load a portion of the charges of colored paint located in each of the removable containers onto the receiving paint area the paint pad transfer member. Although the colored paints located in removable paint containers 26, 27, 28, and 29 may comprise the same color, it is preferred that the colored paints located in removable paint containers 26, 27, 28, and 29 each comprise a different color.

In regards to paint transfer member assembly 48, paint transfer member assembly 48, as shown in the embodiment of FIG. 10A, comprises a base member 34 having first side 35 and a second side 36, a paint pad 37 having a first side 38 for receiving a portion of the charges of color paints located in each of the removable containers thereon and a second side 39, and a handle 41 having a mounting surface 42 located thereon. In the embodiment of FIG. 10A, when paint transfer member assembly 48 is assembled, the mounting surface 42 of the handle 41 is removably secured to the first side 35 of base member 34 through the use of a fastener such as screws or the like and the second side 39 of paint pad 37 is secured to the second side 36 of base member 34. Although the paint pad 37 may be secured to the base member 34 by various methods, in the embodiment of FIG. 10A, the second side 39 of paint pad 37 is secured to the second side 36 of base member 34 through the use of an adhesive 40 located on the second side of paint pad 37.

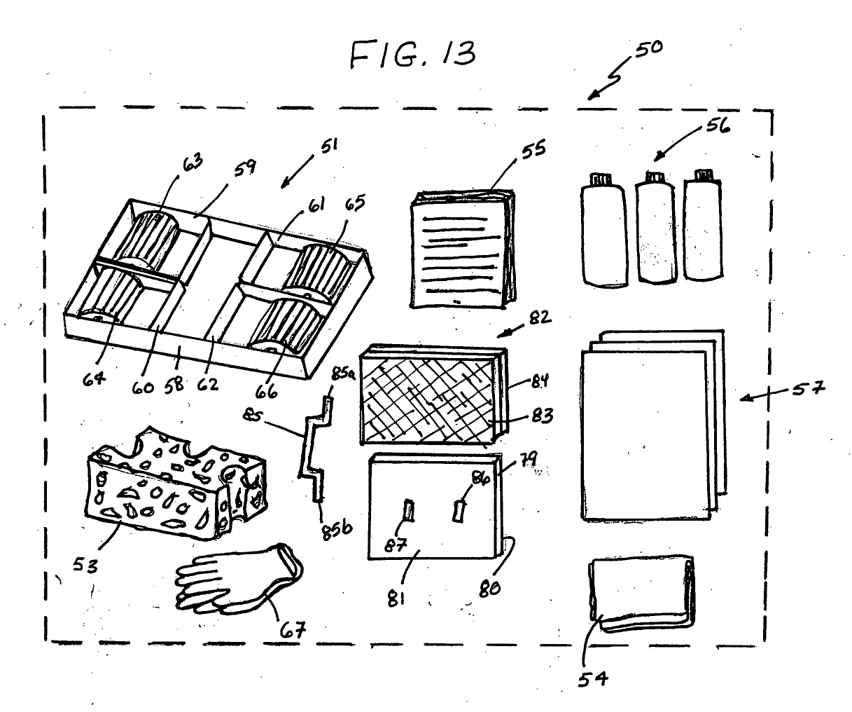

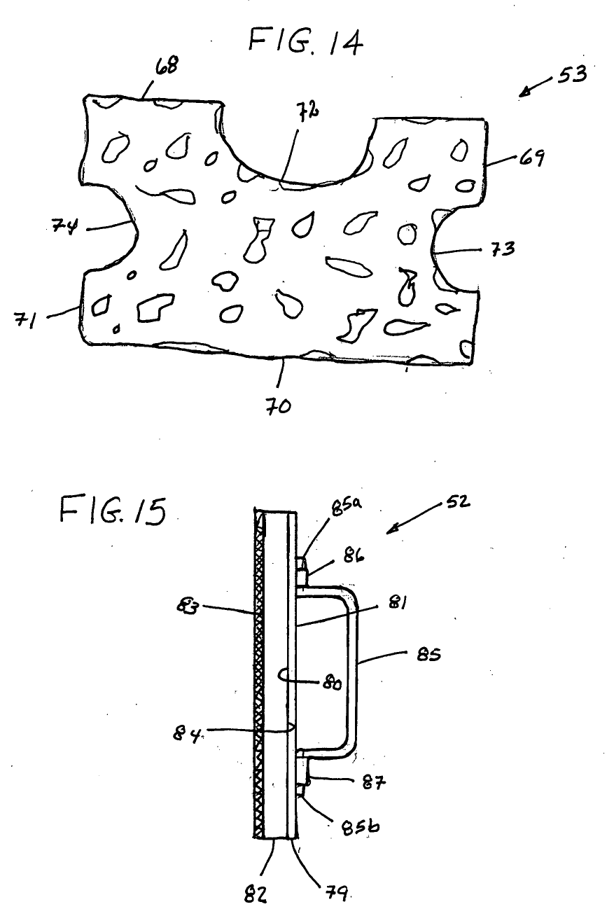

Referring to FIGS. 11 and 12, FIGS. 11 and 12 show examples of other types of paint applicators that can be used with the decorative painting kit of the present inventor for the decorative painting of at least two different colored paints. More specifically, FIG. 11 shows a rag cloth roller applicator 45 for use with the decorative painting kit of the present invention for the painting of the painting technique call rag rolling using at least two different colored paints. FIG. 12 shows a woven fiber roller applicator 12 for use with the decorative painting kit of the present invention for the in situ painting of the painting technique call stucco-rolling or stucco style paint using at least two different colored paints.

Note that unlike the sponge applicator of FIGS. 1, 2, 6, 7, 10 and 10A, in the use of the above-mentioned roller applicators, namely rag cloth roller 45 and the woven fiber roller applicator 46, with the decorative painting kit 10, 24 of the present invention, after the paint transfer member 17 or paint transfer member assembly 48 is loaded with the different colored paints, the different colored paints are then transferred to the aforementioned roller applicators for application to a surface area to be painted by rolling the roller applicators across the surface of the pad region 19 of the paint transfer member 17 or paint transfer member assembly 48. After the roller applicators are loaded with the different colored paints from the paint transfer member 17 or paint transfer member assembly 48, the paint loaded roller applicator is then rolled across the surface area to be painted a sufficient number times to apply and surface blend the different colored paints to produce regions of partially blended colors. As previously noted, a benefit of using the paint transfer member 17 or paint transfer member assembly 48 for loading paint to the paint roller applicator 45 and 46 instead of directly loading paint to the paint roller applicator 45 and 46 is that the paint transfer member 17 or paint transfer member assembly 48 is able to load a uniform amount of different colored paint to the paint roller applicator 45 and 46, thereby eliminating the need for blotting to remove the excess paint from the paint roller applicator before the paint roller applicator is applied to the surface area to be painted.

FIG. 13 shows an alternative embodiment of a decorative painting kit 50 of the present invention similar to decorative painting kit 24 of FIGS. 10 and 10A. Decorative painting kit 50 comprises a paint tray assembly 51, the individual part of a paint transfer member 52, paint applicators comprising sponge applicator 53 and a rag applicator 54 for decoratively applying and partially blending the colored paint to a surface area to be painted, and instructions 55 for using the decorative painting kit 24. Decorative painting kit 50 also include a pair of gloves 67 a set of practice colored paint 56 and a set of colored practice papers 57 for practicing the application and partially blending and layering of the practice colored paint 56 thereon.

In regards to the set of practice colored paint 56 and colored practice papers 57, the set of practice colored paint 56 comprises different colored paint of a sufficient amount to provide the user with a samplings of the potential color and/or color-blend that the user may want to paint a room with. The colored practice papers 57 ideally comprise colors commonly associated a base paint thereby enabling practice papers 57 to mimic the color of a base coat. The application of practice colored paint 56 to practice papers 57 thus provide the user with a future glimpse of what the walls of a room may look like when using a particular paint color(s), color blend, painting style, and the combination thereof.

In regards to paint tray assembly 51, paint tray assembly 51 is similar to paint tray assembly 47 of FIG. 10A in that paint tray assembly 51 comprises a paint tray 58 having a first removable container 59, a second removable container 60, a third removable container 61 and a fourth removable container 62 supported therein. Removable paint containers 59, 60, 61, and 62 each function to support separate charges of colored paint therein.

Located within each of the removable paint containers 59, 60, 61, and 62 is at least one paint dispenser for delivering paint located in the removable container to a paint pad transfer member. More specifically, located in first removable container 59 is a first paint roller dispenser 63, located in second removable container 60 is a second paint roller dispenser 64, located in third removable container 61 is a third paint roller dispenser 65 and located in fourth removable container 62 is a fourth paint roller dispenser 66. Paint roller dispensers 63, 64, 65, and 66 function to load a portion of the charges of colored paint located in each of the removable containers onto the receiving paint area the paint pad transfer member. Similar to the kit 24 of FIGS. 10 and 10A, although the colored paints located in removable paint containers 59, 60, 61, and 62 may comprise the same color, it is preferred that the colored paints located in removable paint containers 59, 60, 61, and 62 each comprise a different color.

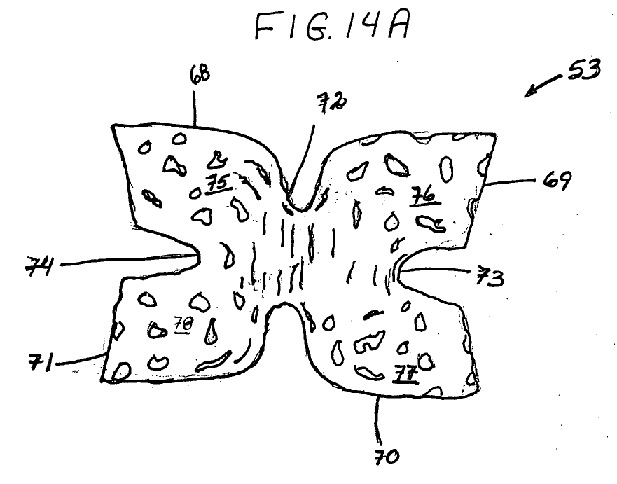

Referring to FIGS. 14, 14A and 15, FIG. 14 shows a close-up side view of the sponge applicator 53 of Kit 50. FIG. 14A shows a side view of the sponge applicator 53 in a distorted condition. FIG. 15 shows a side view of the paint transfer 52. In regards to sponge applicator 53, it is noted that although sponge applicator 53 can be made from a natural sea sponge, sponge applicator 53 preferably is made from a synthetic sponge dues to its environmental friendliness. The embodiment of sponge applicator 53, as shown in FIGS. 14 and 14A includes a first side 68, second side 69, a third side 70, and a fourth side 71. The first side 68 of sponge applicator 53 includes a first finger supporting recess 72, the second side 69 of sponge applicator 53 includes a second finger supporting recess 73, and the fourth side 71 of sponge applicator 53 includes a third finger supporting recess 74. The presence of finger supporting recesses 72, 73, and 74 help keep the different colored paint simultaneously supported by sponge applicator 53 separated from each other.

Although alternative embodiments of the sponge applicator of the present invention can include finger supporting recesses comprising of a variety of shapes and sizes, finger supporting recesses 72, 73, and 74 are shown in FIG. 14 as each having a semicircular configuration with second and third finger supporting recesses 73 and 74 having similar sizes and with first finger supporting recess 72 having a larger size, i.e. a larger radius, than the both the second and third finger supporting recesses 73 and 74. The feature of the differences in the size first finger supporting recess 72 and second and third finger supporting recesses 73 and 74 allow the user to quickly identify the prior orientation of the sponge applicator and to know where the different paint colors are held on the sponge applicator during use.

In use the user grips sponge applicator 53 and applies a squeezing action, which places sponge applicator 53 in the distorted condition as shown in FIG. 14A. The distorted condition of sponge applicator 53 is identified by the presence of four separate paint receiving regions located proximal the corners of sponge applicator 53, namely a first paint receiving region 75, a second paint receiving region 76, a third paint receiving region 77, and a fourth paint receiving region 78. It is noted that paint receiving regions 75, 76, 77, and 78 function to provide for the management of up to 4 different colored paint on sponge applicator 53 to facilitate paint manipulation for decoratively applying and partially blending and layering the colored paint to a surface area to be painted.

In regards to paint transfer member 52, paint transfer member 52 as shown in the embodiment of FIGS. 13 and 15 comprises a paint pad 82 having a first side 83 for receiving a portion of the charges of color paints located in each of the removable containers thereon and a second side 84, a handle 85 having a first end 85a and a second end 85b, and a base member 79 having first side 80 and a second side 81. The second side 80 of base member 79 includes a first mounting slot 86 and a second mounting slot 87 thereon, first mounting slot 86 for receiving the first end 85a of handle 85 therethrough and second mounting slot 87 for receiving the second end 85b of handle 85 therethrough to provide for the mounting of handle 85 to base member 79.

In regards to the first side 83 of paint pad 82, in order to provide for the receival of the charges of color paints thereon, the first side 83 of paint pad 82 includes a paint retaining material generally comprising of a fibered surface located on the first side 83 of paint pad 82. The presence of the paint retaining material on the first side 83 of paint pad 82 enable paint pad 82 to retain the charges of paint thereon no matter the angle the user holds the paint transfer member 52 thereby allowing the user to carry the charges of paint to various painting locations without the fear of paint dripping from paint transfer member 52.

Referring to FIG. 15, when paint transfer member 52 is assembled, handle 41 is removably secured to the second side 81 of base member 79 and the second side 84 of paint pad 82 is secured to the first side 80 of base member 79. Although the paint pad 82 may be secured to the base member 79 by various methods, in the embodiment of FIG. 15, the second side 84 of paint pad 82 is secured to the first side 80 of base member 79 through the use of an adhesive or the like located on the second side of paint pad 82.

The present invention includes a method of decorative painting comprising the steps of (1) applying a load of at least two different color paints to a paint transfer member; (2) transferring at least one of the at least two different color paints from the paint transfer member to a paint applicator; and (3) repeatedly contacting a surface area to be painted with the paint applicator to transfer the at least one of the two different color paints on the paint applicator to the surface to produce a decorative pattern.

The above method further include the steps of (4) repeatedly contacting a surface area to be painted with the paint applicator to first transfer a first colored paint followed by the transfer of a second colored paint to surface area to be painted while the first colored paint is still wet to produce a decorative pattern under a wet-against-wet condition; (5) placing the at least two different color paints into at least two separate containers with each of the separate containers holding a charge of different color paint and loading a portion of the charge of the at least two different colored paints on the paint transfer member with each of the different colored paints loaded to a different area of the paint transfer member; (6) loading a portion of the charge of the at least two different colored paints on the paint transfer member with each of the different colored paints loaded to a different area of the paint transfer member through the use of a paint dispenser located in each of the separate containers; (7) simultaneously moving the paint transfer member tangentially across a set of paint roller dispensers comprising at least one paint roller dispenser located in each of the separate containers to load the portion of the charge of the at least two different colored paints on the paint transfer member; (8) repeatedly daubing the surface area to be painted with a sponge paint applicator to transfer the at least one of the two different color paints on the paint applicator to the surface to be painted to produce the decorative pattern; (9) repeatedly stroking the surface area to be painted with the paint applicator to transfer the at least one of the two different color paints on the paint applicator to the surface to produce the decorative pattern; (10) repeatedly rolling a roller applicator on the surface area to be painted to transfer the at least one of the two different color paints on the paint applicator to the surface to produce the decorative pattern; (11) transferring a sufficient amount of paint to the paint transfer member to enable paint transfer on at least 8 surface contacts between the paint applicator and the surface area; (12) varying the pressure of the surface contact between the paint applicator and the surface area; and (13) changing the contact area of the paint applicator during the repeatedly contacting of the surface area to be painted.

The present invention includes a method of decorative painting comprising the steps of (1) applying a load of paint to a paint transfer member; (2) transferring the load of paint from the paint transfer member to a paint applicator; and (3) repeatedly contacting a surface area to be painted with the paint applicator to transfer at least a portion of the load of paint to produce a decorative pattern.

The above method further include the steps of (4) placing a charge of paint into a container and loading a portion of the charge of paint on the paint transfer member; (5) loading the portion of the charge of paint on the paint transfer member through a paint roller dispenser located in the container; (6) repeatedly daubing the surface area to be painted with a sponge paint applicator; and (7) repeatedly rolling a roller applicator on the surface area to be painted.

I claim:

1. A paint kit for decorative color painting comprising:
a paint tray;
at least two separate containers supported in the paint tray, each of the containers for holding a charge of a different color paint therein;
a paint transfer member for receiving and carrying a portion of the charge of at least two different color paints in a side-by-side condition;
a paint roller dispenser located in each of the separate containers, the paint roller dispenser for simultaneously loading the portion of the charge of at least two different colored paints located in the containers onto the paint transfer member; and
a sponge paint applicator for lifting at least a partial load of one of the at least two different color paints from the paint transfer member and applying the one of the at least two different colored paints to a surface area to be decoratively painted through contact between the paint applicator and the surface area to be decoratively painted.

2. The paint kit of claim 1 wherein the at least two separate containers of the paint tray comprises at least two separate containers that are each individually removable from the paint tray for holding the charge of the at least two different colored paints.

3. The paint kit of claim 1 wherein the at least two separate containers for holding the charge of the at least two different colored paints comprises four separate containers each for holding a charge of a different colored paint therein, the four separate containers each having a paint dispenser located therein.

4. The paint kit of claim 1 wherein the paint transfer member comprises:
a base member having a first side and a second side;
a paint pad having a first side and a second side, the first side of the paint pad for receiving the portion of the charge of at least two different color paints in a side-by-side condition thereon, the second side of the paint pad for securably engaging the first side of the base; and
a handle having a mounting surfaces thereon, the mounting surface of the handle for securably engaging a portion of the second side of the base.

5. A method of decorative painting comprising the steps of:
applying a load of at least two different color paints to a paint-transfer member;
transferring at least one of the at least two different color paints from the paint transfer member to a paint applicator; and
repeatedly contacting a surface area to be painted with the paint applicator to transfer the at least one of the two different color paints on the paint applicator to the surface to produce a decorative pattern.

6. The method of claim 5 wherein the step of repeatedly contacting the surface area to be painted with the paint applicator comprises repeatedly contacting the surface area to be painted with the paint applicator to first transfer a first colored paint followed by the transfer of a second colored paint to the surface area to be painted while the first colored paint is still wet to produce a decorative pattern under a wet-against-wet condition.

7. The method of claim 5 including the steps of placing the at least two different color paints into at least two separate containers with each of the separate containers holding a charge of different color paint and loading a portion of the charge of the at least two different colored paints on the paint transfer member with each of the different colored paints loaded to a different area of the paint transfer member.

8. The method of claim 7 wherein the portion of the charge of the at least two different color paints are loaded on the paint transfer member by simultaneously moving the paint transfer member tangentially across at least one paint roller dispenser located in each of the separate containers.

9. The method of claim 5 wherein the step of repeatedly contacting the surface area to be painted with the paint applicator to transfer the at least one of the two different color paints on the paint applicator to the surface comprises repeatedly daubing the surface area to be painted with a sponge paint applicator to transfer the at least one of the two different color paints on the paint applicator to the surface to produce the decorative pattern.

10. The method of claim 5 wherein the step of repeatedly contacting the surface area to be painted with the paint applicator to transfer the at least one of the two different color paints on the paint applicator to the surface comprises the step of repeatedly rolling a roller applicator on the surface area to be painted to transfer the at least one of the two different color paints on the paint applicator to the surface to produce the decorative pattern.

11. The method of claim 5 including the step transferring a sufficient amount of paint to the paint transfer member to enable paint transfer on at least 8 surface contacts between the paint applicator and the surface area.

12. The method of claim 5 including the step of varying the pressure of the surface contact between the paint applicator and the surface area.

13. A paint kit for decorative color painting comprising:
a paint transfer member for receiving and carrying a load of at least two different color paints in a side-by-side condition; and
a paint applicator for lifting at least a partial load of the at least two different color paints from the paint transfer member and applying and blending the at least two different colored paints on a surface through contact between the paint applicator and a surface area to be decoratively painted.

14. The paint kit of claim 13 including at least two separate containers each having a paint dispenser located therein, each of the containers for supporting a different color paint therein.

15. The paint kit of claim 13 including a tray for supporting the at least two separate containers therein.

16. The paint kit of claim 15 wherein the tray for supporting the at least two separate containers therein comprises a shipping carton.

17. The paint kit of claim 13 wherein the paint applicator comprises a sponge applicator.

18. The paint kit of claim 13 wherein the paint transfer member includes a paint receiving area having surface protrusions for retaining paint in a localized area.

19. The paint kit of claim 13 wherein the paint transfer member includes a paint-receiving area having bristles thereon.

20. The paint kit of claim 14 wherein the at least two separate containers of the paint tray comprises at least two separate containers that are each individually removable from the paint tray for holding at least two different colored paints.
